(19) United States
(12) Patent Application Publication
(10) Pub. No.: US 2026/0251113 A1
(43) Pub. Date: Aug. 27, 2026

(54) System and Method for Actuating a Turbine Assembly

(71) Applicant: Edward Anthony Hill, Carlsbad, CA (US)

(72) Inventor: Edward Anthony Hill, Carlsbad, CA (US)

(21) Appl. No.: 19/548,400

(22) Filed: Feb. 24, 2026

Related U.S. Application Data
(60) Provisional application No. 63/762,175, filed on Feb. 24, 2025.

(51) Int. Cl. F03B 11/00; F03B 15/00; F03B 17/06

(52) U.S. Cl. CPC F03B 11/008; F03B 15/00; F03B 17/062

(57) ABSTRACT

A system for actuating a turbine assembly includes a debris detection system configured to be disposed upstream of a turbine assembly having at least one foil configured to be disposed in water. The debris detection system includes at least one prong configured to be disposed in water, the at least one prong configured to detect debris upstream from the turbine assembly, and a computing device communicatively coupled to the at least one prong and the turbine assembly. The computing device has a memory executed by a processor and configured to: receive a signal from the at least one prong upon the at least one prong detecting debris; and send a signal to the turbine assembly to actuate the at least one foil of the turbine assembly, removing the at least one foil of the turbine assembly from the water to avoid the debris.

### FIELD OF THE DISCLOSURE

The present disclosure generally relates to a turbine assembly and, in particular, a system and method for actuating a turbine assembly on a floating platform.

### BACKGROUND

Sustained grid-connected hydrokinetic power generation in some remote rivers has never been achieved. Prior attempts have failed due to one or more challenges. Such challenges include large debris, such as whole trees, which may be present at any depth and damage turbines or submerged mooring lines. In addition, high sediment concentrations exist in various rivers, resulting in premature failure of submerged electrical cables, bearings, seals, or turbine blades due to scouring, for example. Further, accumulation of debris on diverters or turbine platforms occurs, which may result in damage and/or require periodic high-risk intervention in swift water. Also, there is difficulty of deployment and/or retrieval in of the turbine assembly in uncontrolled river environments without specialized equipment and/or vessels.

Additional challenges which must be addressed to enable resilient, low-cost, and scalable river energy for arctic communities, such as those situated on the Yukon River and similar rivers worldwide include: survival in swift, turbulent spring flows with maximum velocities that vary year-to-year; river channel migration: dynamic change of river shape and bathymetry over time due to erosion and sediment transport; enablement of local installation, operation, and maintenance without requiring advanced technical training; and detection of submerged debris which may damage the turbine assembly but is not visible from above the water surface. Further challenges include ensuring rivers remain navigable by all regional vessels, fulfillment of all environmental, social, and regulatory requirements, modular and robust microgrid integration, and cost-effective power extraction in shallow and low-resource environments, which maximizes public benefit, increases market size, and provides flexibility for deployment in slower current locations which are less debris-prone.

Other turbine architectures that are robust to some amount of debris impact and deployed from a floating platform have been proposed; however the proposed approaches mandate a deployment platform that is also robust to debris, for example. While debris diverters have proven effective at protecting river energy converters that are deployed near the surface in close proximity, a significant decrease in the power generated by the turbine assembly may result due to the diverter. Further, the diverter structure and mooring line must be capable of impact loading and subsequent sustained force, and the associated cost of fabrication, transport, and installation may be significant.

### SUMMARY

In accordance with a first aspect, a system for actuating a turbine assembly including: a debris detection system configured to be disposed upstream of a turbine assembly having at least one foil configured to be disposed in water, the debris detection system including: at least one prong configured to be disposed in water and coupled to one of a cable or a boom, the at least one prong configured to detect debris upstream from the turbine assembly; and a computing device communicatively coupled to the at least one prong and one or more actuators , the computing device having a memory executed by a processor and configured to: receive a signal from the at least one prong upon the at least one prong detecting debris; and send a signal to the at least one actuator to actuate the at least one foil of the turbine assembly, removing the at least one foil of the turbine assembly from the water to avoid the debris.

In accordance with another aspect, a method for actuating a turbine assembly comprises disposing a debris detection system upstream of a turbine assembly having at least one foil configured to be disposed in water, the debris detection system including at least one prong configured to be disposed in water and coupled to one of a cable or a boom; detecting debris upstream from the turbine assembly by the at least one prong; receiving a signal from at least one component of the debris detection system indicating the debris is detected; and actuating one or more of the turbine assembly to remove the at least one foil of the turbine assembly from the water; and an entire floating platform to which? the turbine assembly is coupled away from the debris or to a shoreline.

In accordance with yet another aspect, a system for actuating a turbine assembly comprises one or more capstans configured to be disposed on land which actuate a cable or cables configured to be coupled to a portion of a floating platform which the turbine assembly is mounted to disposed in water. The system also comprises a boom configured to be anchored on land and having one of: (1) a portion coupled to the floating platform; (2) a portion coupled to the cable or (3) the turbine assembly disposed on the boom. So configured, upon debris being detected, one or more of the cables of the capstans or the boom is actuated to move the floating platform and therefore the turbine assembly away from the debris.

In accordance with yet another example, a method for actuating a turbine assembly includes detecting, via a debris detection system, debris, and upon the debris being detected, determining if the debris detected adversely affects a turbine assembly. The method also includes, upon determining the debris adversely affects the turbine assembly, actuating the turbine assembly to remove the turbine assembly out of water until the debris passes. After determining the debris detected adversely affects the turbine assembly, the method further includes determining if the debris detected adversely affects a floating platform, and, upon determining the debris detected adversely affects the floating platform, actuating the floating platform to move the floating platform away from the detected debris and/or to a shoreline until the debris passes.

### BRIEF DESCRIPTION OF THE DRAWINGS

It is believed that the disclosure will be more fully understood from the following description taken in conjunction with the accompanying drawings. Some of the drawings may have been simplified by the omission of selected elements for the purpose of more clearly showing other elements. Such omissions of elements in some drawings are not necessarily indicative of the presence or absence of particular elements in any of the example embodiments, except as may be explicitly delineated in the corresponding written description. Also, none of the drawings is necessarily to scale.

FIG. 1A is a perspective view of an exemplary system for actuating a turbine assembly according to an aspect of the present disclosure;

FIG. 1B is a block diagram of a computing device of the system of FIG. 1A;

FIG. 1C is a perspective view of a portion a debris detection system of the exemplary system of FIG. 1A;

FIG. 1D is a perspective view of the portion of the debris detection system of the exemplary system of FIG. 1A suspended from a cable;

FIG. 1E is a perspective view of the portion of the debris detection system of the exemplary system of FIG. 1A disposed on a boom;

FIG. 2 is a perspective view of the system of FIG. 1A with a debris detection system further including a carriage;

FIG. 3 is a perspective view of another exemplary system for actuating a turbine assembly according to another aspect of the present disclosure, the system including a debris detection system having at least one capstan;

FIG. 4 is a perspective view of still another exemplary system for actuating a turbine assembly according to yet another aspect of the present disclosure, the system including a debris detection system having a boom and at least one capstan;

FIG. 5 is a perspective of the exemplary system of FIG. 4 with a turbine assembly disposed on the boom;

FIG. 6 is a perspective view of another exemplary system for actuating a turbine assembly according to yet another aspect of the present disclosure, the system including a debris detection system having a boom actuated in a linear direction;

FIG. 8A is a perspective view of another exemplary system for actuating a turbine assembly according to another aspect of the present disclosure;

FIG. 8B is a portion of a debris detection system of the exemplary system of FIG. 8A;

FIG. 8C is a perspective view of the portion of the debris detection system of the exemplary system of FIG. 8A suspended from a cable;

FIG. 8D is another perspective view of the exemplary system for actuating a turbine assembly of FIG. 8A with a floating platform retracted to a position near shore.

FIG. 8E is another perspective view of the exemplary system of FIG. 8A, with a floating platform deployed to an optimal position for power generation;

FIG. 8F is an overhead view of an exemplary floating platform of the exemplary system of FIG. 8A, such as a catamaran;

FIG. 8G is an elevation view of the exemplary floating platform of FIG. 8F; .

FIG. 9A is a perspective view of another exemplary system for actuating a turbine assembly which is affixed to a floating platform according to another aspect of the present disclosure;

FIG. 9B is a perspective view of the exemplary system of FIG. 9A with the floating platform of the exemplary system in a retracted position;

FIG. 9C is a perspective view of the exemplary system of FIG. 9A with the floating platform of the exemplary system in a deployed position;

FIG. 10 is a block diagram depicting steps of an exemplary method of detecting debris using an exemplary system of the present disclosure;

FIG. 11 is an overhead view of another exemplary system for actuating a turbine assembly according to yet another aspect of the present disclosure;

FIG. 12 is an overhead view of another exemplary system for actuating a turbine assembly according to yet another aspect of the present disclosure; and

FIG. 13 is and overhead view of another exemplary system for actuating a turbine assembly according to yet another aspect of the present disclosure.

### DETAILED DESCRIPTION

Generally, the invention relates to a system designed to actuate a power-generating turbine assembly and/or an entire floating platform on which the turbine assembly is mounted on for the purpose of avoiding debris in water and enabling deployment of a turbine assembly in an optimal location without requiring submerged anchor lines or any electrical cables, such that only the turbine blades and floating platform are partially submerged. The turbine assembly includes an electrical generator and a power transmission cable which transmits power from the generator to a grid or battery charging system connection point. This system includes a debris detection system positioned upstream of the turbine assembly, which comprises at least one prong situated in water in one example. The debris detection system may also include a pair of towers, with at least one tower being placed on land, and a cable stretched between the towers. Suspended from the cable via sheaves that ride on the cable is a debris detection system carriage to which a camera, illumination source, and at least one prong having one or more integrated sensors are coupled. The at least one prong may be articulated and/or flexible and/or rigid and is immersed in water and tasked with detecting debris upstream from the turbine assembly. Additionally, a computing device is in communication with both the prong(s), the cameras, the vertical actuator that is coupled to the floating platform and turbine assembly which adjusts the operating depth of the turbine or removes it completely from the water. The computing device is also coupled to an actuation system that may move the entire floating platform on which the vertical actuator and turbine system is mounted. The computing device is programmed to receive signals from the prong(s) and/or cameras when debris is detected and, in response, send signals to a vertical actuator and/or a floating platform actuator(s), in some examples. For example, the signals prompt the actuation of the vertical actuator, causing the turbine foils to be removed from the water to evade the detected debris and/or cause the entire floating platform to which the vertical actuator and turbine assembly are mounted on to move away from the debris or to the shoreline. In another example, the shoreline location may be further protected by a permanent diverter structure.

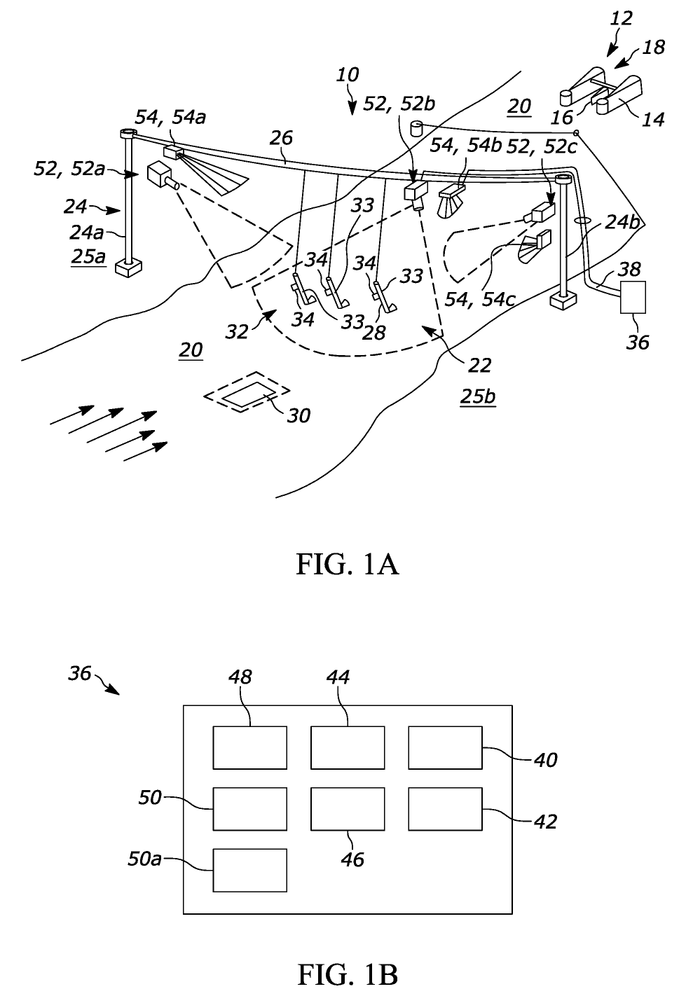

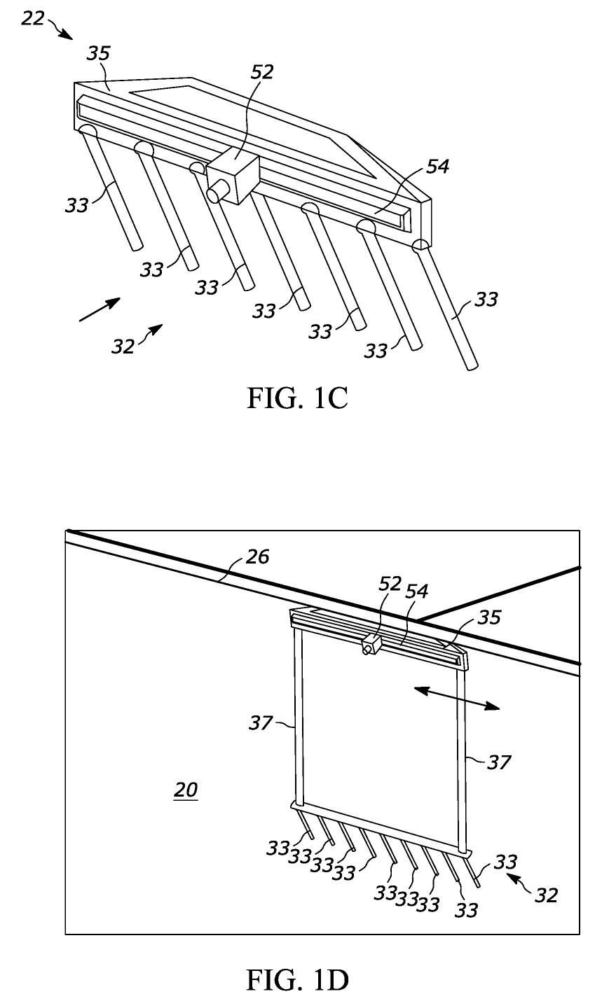

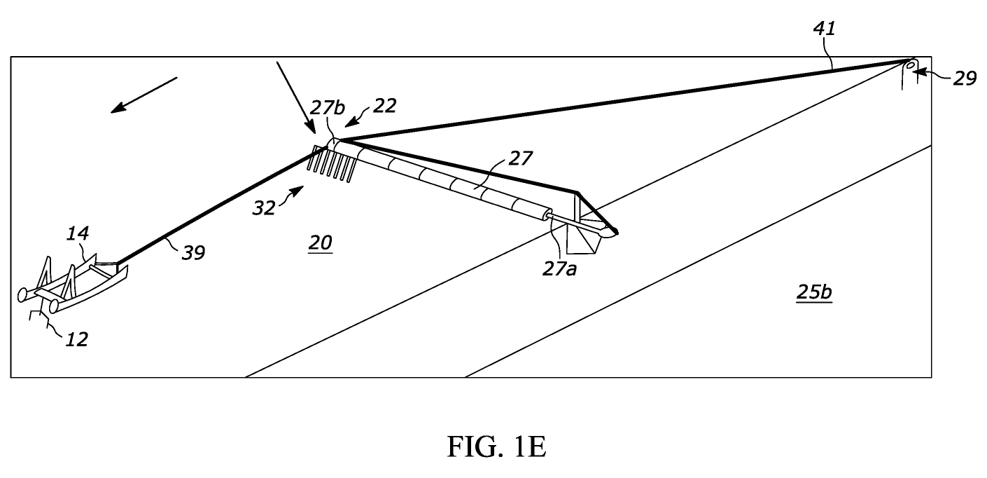

More specifically, and referring now to FIG. 1A, a system 10 for actuating a turbine assembly 12 is disclosed. In this example, the turbine assembly 12 is disposed on a floating platform 14 and includes at least one foil 16 configured to be disposed in water 20. In another example, the at least one foil 16 includes a plurality of foils 18, with each foil also configured to be disposed in water. In another example, only the portion of the at least one foil 16 of the turbine assembly 12 is disposed in the water and removed from the water upon actuation after detecting debris, such as the debris 30.

The system 10 includes a debris detection system 22 configured to be disposed upstream the turbine assembly 12, as depicted in FIG. 1A, for example. In this example, the debris detection system 22 includes a pair of towers 24 with at least one tower 24a configured to be disposed on land. More specifically, in one example, the pair of towers 24 includes a first tower 24a configured to be disposed on land 25a adjacent to the water 20, and a second tower 24b configured to be disposed on land also adjacent to the water 20 but on an area opposite the land in which the first tower 24a is disposed. A cable 26 is disposed between the pair of towers 24, and at least one prong 28 is coupled to and suspended from the cable 26 and configured to be disposed, at least partially disposed, in the water 20. The at least one prong 28 is configured to detect debris 30 upstream from the turbine assembly 12.

In one example, and as depicted in FIG. 1A, the at least one prong 28 includes a plurality of prongs 32 that is coupled to and suspended from the cable 26 and configured to be disposed in the water 20. The plurality of prongs 32 may include any number of prongs 33, such as three prongs 33, as depicted in FIG. 1. It will be appreciated that more prongs 33 may be included as part of the plurality of prongs 32 and still fall within the scope of the present disclosure. The at least one prong 28 and each prong 33 of the plurality of prongs 32 includes an accelerometer or sensor 34 coupled thereto and configured to detect debris 30 located upstream the turbine assembly 12. Specifically, the accelerometer or sensor 34 will detect impact of any debris contacting the at least one prong 28. It will be appreciated that other devices different from the accelerometer or sensor 34 and capable of detecting debris, such as the debris 30, such as one or more sensors, may alternatively be coupled to the prongs 28, 33 and still fall within the scope of the present disclosure.

Still referring to FIG. 1A, the system 10 also includes at least one computing device 36 communicatively coupled to the at least one prong 28, 33 and the turbine assembly 12 by way of wireless network and/or a wired connection, such as electrical cables 38. The computing device 36 includes a memory 40, at least one processor 42, a transmitter 44, a receiver 46, a network interface 48, and a display 50, as depicted in FIG. 1B. So configured, the memory 40 of the computing device is executed by the processor 42 and configured to receive a signal from the at least one prong 28 upon the at least one prong 28 detecting debris and send a signal to the turbine assembly 12 to actuate the at least one foil 16, removing the at least one foil 16 of the turbine assembly 12 from the water 20 to avoid the debris, such as the debris 30.

In some examples, the system 10 also includes a plurality of cameras 52, and each camera of the plurality of cameras 52 is coupled to one of the towers 24a, 24b of the pair of towers 24 or the cable 26, for example, and further communicatively coupled to the computing device 36. More specifically, and in the example depicted in FIG. 1A, a first camera 52a of the plurality of cameras 52 is coupled to the tower 24a, a second camera 52b is coupled to the cable 26, and a third camera 52c is coupled to the other tower 24b. It will be appreciated that only a single camera, such as the first camera 52a, may be used or more than three cameras may also be used and still fall within the scope of the present disclosure. So configured, the computing device 36 is configured to receive a signal from at least one camera 52a, 52b, and 52c of the plurality of cameras 52 upon one or more of the cameras 52a, 52b, 52c detecting debris and/or debris contacting the at least one prong 28.

In another example, the system 10 may also include a plurality of illumination sources 54, and each illumination source of the plurality of illumination sources 54 is disposed adjacent to each camera 52a, 52b, 52c of the plurality of cameras 52. As such, each illumination source is likewise be coupled to one of the towers 24a, 24b or the cable 26. More specifically, and again in the example of FIG. 1A, a first illumination source 54a is coupled to the first tower 24a adjacent to the first camera 54a, a second illumination source 54b is coupled to the cable 26 adjacent to the second camera 52b, and the third illumination source 54c is coupled to the tower 24b adjacent to the third camera 52c. It will again be appreciated that fewer or more than three illumination sources may alternatively be used and still fall within the scope of the present disclosure.

Referring now to FIG. 1C, a portion of the debris detection system 22 is depicted. Specifically, in this example, the plurality of prongs 32 extends from a body 35, with each prong 33 extending downwardly from the body 35 such that only a portion of each prong 33 is disposed in the water. In addition, the at least one camera 52 is coupled to the body 35 along with the at least one illumination source 54, which is disposed adjacent to the at least one camera 52. So configured, the body 35 enables this portion of the debris detection system 22 to be more easily disposed on various other structures, e.g., a boom, as explained more below, and still function as described above, for example.

Referring now to FIG. 1D, the at least one prong 33 of the plurality of prongs 32 is coupled to the cable 26. In this example, and more specifically, the body 35 is coupled to the cable 26 and includes arms 37 downwardly extending from the body 35 to which the plurality of prongs 32 are coupled. Each prong 33 of the plurality of prongs 32 is disposed in the water, for example.

Referring now to FIG. 1E, the debris detection system 22 depicted in FIG. 1C is coupled to a boom 27. The boom 27 includes a first end 27a disposed on land 25b and a second end 27b disposed OVER the water 20 and to which the debris detection system 22 is coupled. The floating platform which the turbine assembly 12 is mounted on is coupled to the second end 27b of the boom 27 via a cable 39. A capstan 29, which is disposed on the land 25b, is also coupled to the second end 27b of the boom 27 via another cable 41.

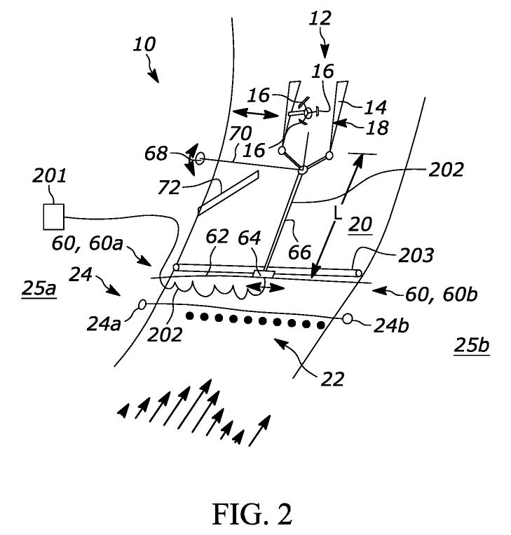

Referring now to FIG. 2, the debris detection system 22 of the system 10 of the FIG. 1A is depicted with a carriage. More specifically, the debris detection system 22 includes a second pair of towers 60 adjacent to and downstream the first pair of towers 24. The second pair of towers 60 includes a first tower 60a disposed on land 25a and a second tower 60b also disposed on land 25b and on a side of the water 20 opposite to the first tower 60a. A cable 62 is coupled to each tower 60a, 60b and disposed between the towers 60a, 60b. A carriage 64 is disposed on the cable 62 and moveable along the length of the cable 62 from the first tower 60a to the second tower 60b on the other side of the water 20, for example. The carriage 64 also includes another cable 66 couple thereto and extending therefrom and to a portion of the floating platform 14 and/or turbine assembly 12, as depicted in FIG. 2. So configured, when the debris detection system 22, including the carriage 64 in this example, detects debris in the water 20, the carriage 64 actuates the cable to move the turbine assembly 12 away from the debris. The carriage 64 may be actuated by various methods, such as a power belt and pulley system 203, to move it along the length of the cable 62 and position the floating platform 14 in various positions in the river, such as near shore or in the middle of the river. It should be noted that in one example power generated by the turbine assembly 12 would be delivered to shore via an above-water power cable 202 to a load or grid connection point 201. It will be appreciated that in this embodiment a portion of the power cable 202 that runs along cable 66 could be replaced by a DC bus bar. Additional electrical cables, such as for data, signals, or turbine system component power, would be run above the water in a similar manner. So configured, none of the electrical wires or cables, e.g., the power cable 202, is disposed underwater.

In addition, the system 10 of FIG. 2 may further include a capstan 68 configured to be disposed on land 25a or above the land 25a, 25b The capstan 68 includes a cable 70 extending therefrom and coupled to another portion of the turbine assembly 12. When the debris detection system 22, including the carriage. 64 in this example, detects debris, the cable 70 of the capstan 68 is actuated to move the turbine assembly 12 away from the detected debris. In some examples, a diverter 72 disposed on land, such as the land 25a, and extending into the water 20 (such as a river), such that when the cable 70 of the capstan 68 is actuated, the cable 70 of the capstan 68 moves the turbine assembly 12 toward the diverter 72, which then directs the turbine assembly 12 in an area of the water 20 away from the debris.

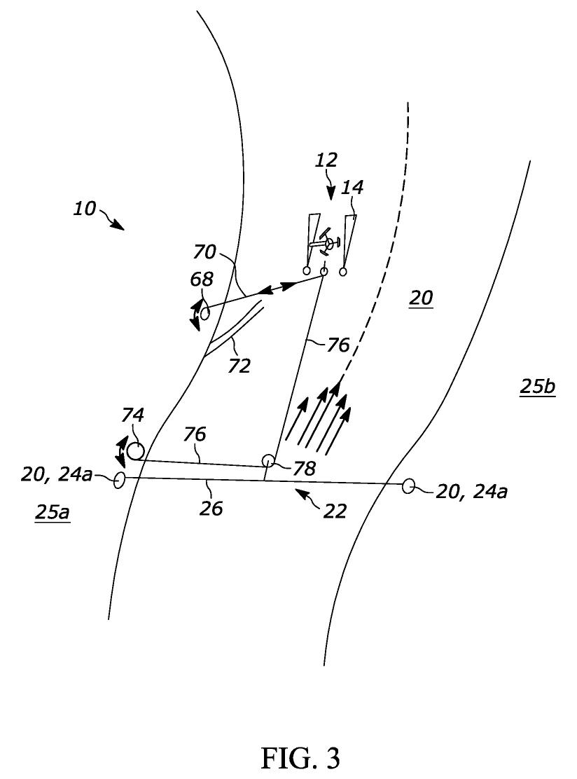

Referring now to FIG. 3, the system 10 of FIG. 1A is depicted with the capstan 68 and the diverter 72 along with a second capstan 74, as explained more below. Parts of the debris detection system 22 and the system 10 previously explained in one or more of FIGS. 1A and 2 will not be described again here for the sake of brevity. As noted, the system 10 in this example further includes a second capstan 7274 disposed on the land, such as the land 25a, between the first tower 20a of the pair of towers 20 and the first capstan 68. Like the first capstan 68, the second capstan 72 74 also includes a wire cable 76 extending therefrom that is coupled to another cable guided by sheave 78 extending from the cable 26 disposed between the first and second towers 20a, 20b. The cable 76 78 is coupled to a portion of the floating platform 14 and/or turbine assembly 12. So configured, when debris is detected, such as by the debris detection system 22, for example, the wire cable 76 of the second capstan 74 may also be actuated simultaneously with capstan 68 to move the floating platform 14 and turbine assembly 12 in a direction toward the land 25a and the second capstan 74, avoiding to avoid contact with the debris or to a more optimal deployed position.

In view of the foregoing, one of ordinary skill will understand that the system 10 described above may be involved in a method of actuating the turbine assembly 12. For example, in one example, the method includes disposing the debris detection system 22 upstream the turbine assembly 12 having at least one foil configured to be disposed in water. As explained in detail above, the debris detection system 22 includes at least one prong 28 configured to be disposed in the water 20 and coupled to one of the cable 26 disposed between the pair of towers 20 (see, e.g., FIG. 1A) or the boom 27 (see, e.g., FIG. 1E). The method further includes detecting the debris, such as the debris 30, upstream from the turbine assembly 12 by the at least one prong 28, and then receiving a signal from at least one component of the debris detection system 22, indicating the debris 30 is detected, including debris which is near the surface of the water 20 but fully submerged and therefore not visible. While one or more cameras detect most floating debris, prongs detect debris that is submerged but near the surface of the water, for example, and thus not visible to the one or more cameras. The method also includes actuating the turbine assembly 12 to remove the at least one foil of the turbine assembly 12 from the water 20.

In one example, disposing the debris detection system 22 upstream the turbine assembly 12 having at least one foil configured to be disposed in water comprises disposing the debris detection system 22 upstream the turbine assembly 12, the at least one prong 28 including the plurality of prongs 32, and each prong 33 of the plurality of prongs 32 configured to be disposed in the water and having the accelerometer or sensor 34 coupled thereto.

In another example, detecting debris upstream from the turbine assembly 12 by the at least one prong 28 comprises detecting debris upstream from the turbine assembly by a plurality of prongs 32, each prong 33 having a portion disposed in the water and an accelerometer or sensor 34 coupled thereto.

In another example, receiving a signal from at least one component of the debris detection system 22 indicating the debris 30 is detected comprises receiving a signal from at least one of: (1) the at least one prong 28 of the debris detection system 22; and (2) at least one camera 52 coupled to at least one tower 24a, 24b indicating debris is present.

In yet another example, receiving a signal from at least one component of the debris detection system 22 indicating the debris 30 is detected comprises receiving a signal from a plurality of cameras 52, at least one camera 52a coupled to a tower 24a and indicating debris which potentially damage the turbine assembly 12 and/or floating platform 14 is present.

In yet another example, actuating the at least one foil 16 of the turbine assembly 12 to remove the at least one foil 16 of the turbine assembly 12 from the water comprises vertically actuating the at least one foil 16 of the turbine assembly 12 to remove the at least one foil 16 of the turbine assembly 12 from the water.

In another example, actuating the turbine assembly 12 to remove the at least one foil 16 of the turbine assembly 12 from the water 20 comprises one or more of: (1) actuating the at least one foil 16 of the turbine assembly to remove the at least one foil of the turbine assembly from the water; and (2) sending a signal via a processor of the computing device 36 communicatively coupled to the at least one prong 28 and the turbine 12 assembly to actuate the at least one foil 16 of the turbine assembly 12 to remove the at least one foil 16 of the turbine assembly 12 from the water 20. In still another example, the method includes disposing the turbine assembly 12 on the floating platform 14, such that only a portion of the at least one foil 16 of the turbine assembly 12 is disposed in the water 20 and the rest of the turbine assembly 12 is disposed on the platform 14.

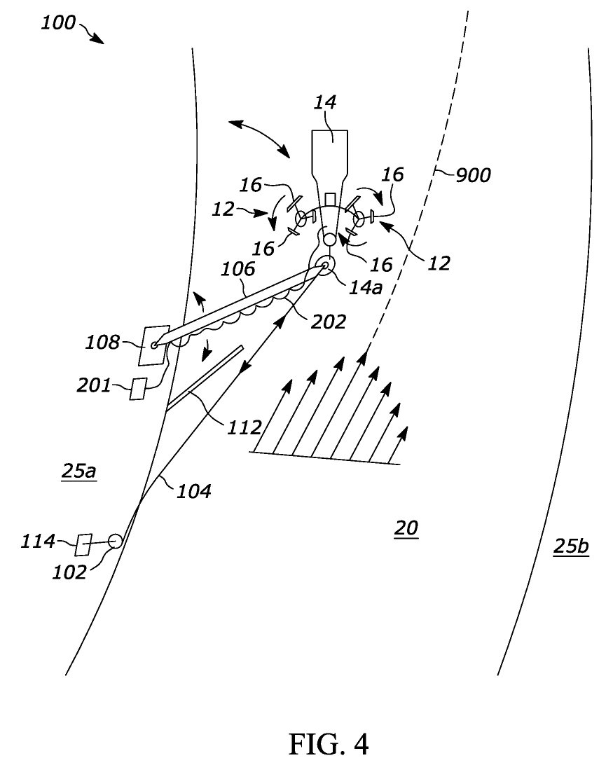

Referring now to FIG. 4, another exemplary system 100 for actuating the turbine assembly 12 according to yet another aspect of the present disclosure is depicted. The system 100 includes a capstan 102 configured to be disposed on land 25, such as the area of land 25a, and having a cable 104, such as an anchor line, configured to be coupled to a portion of the turbine assembly 12 or the portion 14a of the floating platform 14 on which the turbine assembly 12 is disposed. The platform 14 with the turbine assembly 12 disposed thereon is disposed in the water 20, as depicted in FIG. 4. The system 100 further includes a boom 106, such as a rigid boom, configured to be anchored on the land 25a and having a portion of the boom 106 coupled to the portion of the turbine assembly 12 or the portion 14a of the floating platform 14 on which the turbine assembly 12 is disposed. In this way, the platform 14 helps support the boom 106.

In addition, in this example, the boom 106 may be coupled to a base 108 disposed on the land So configured, upon debris being detected, the cable 104 of the capstan 102 is actuated to play out cable and allow the water current to move the platform 14 having the turbine assembly 12 towards land 25a and away from the debris. It should be noted that power generated by the turbine assembly 12 would be delivered to shore via an above-water power cable 202 to a load or grid connection point 201. Additional electrical cables, such as for data, signals, or turbine system component power, would be run above the water in a similar manner.

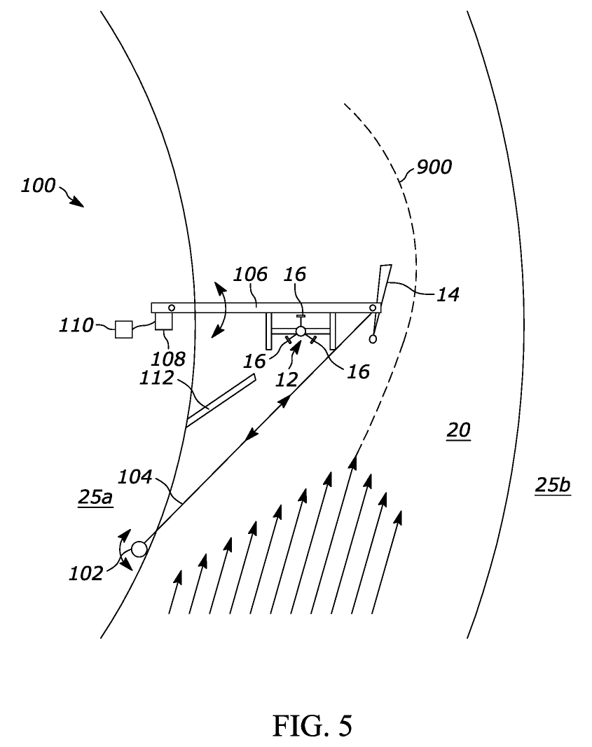

As further depicted in FIG. 4, the system 100 may further include a diverter 112 disposed on the land 25a and extending into the water 20. Upon debris being detected, the cable 104 of the capstan 102 is played out to allow the water current to move the turbine assembly 12 toward the diverter 112, directing the turbine assembly 12 and the platform 14 away from the debris. In addition, each of the boom 106 and the capstan 102 may deploy the turbine assembly 12 disposed on the platform 14 in a desired area of the water, such as on the inside radius of a thalweg 900 of a river, as also depicted in FIG. 5. In this way, the turbine assembly 12 disposed on the platform 14 is exposed to less debris than if the turbine assembly 12 disposed on the platform was within the thalweg of the water or river, for example.

Further, the system 100 may also include at least one tower 114 configured to be disposed on the land 25a, and the capstan 102 is disposed on the tower 114, such that the cable 104 coupled to the turbine assembly 112 is disposed entirely above the water. In another example, the capstan 102 may be configured to be disposed on the land 25a, and the cable 104 may be coupled to the tower 114 and to the boom 106.

FIG. 5 is a perspective of the exemplary system of FIG. 4 with the turbine assembly 12 disposed on the boom 106. More specifically, the floating platform 14 is coupled to the boom 106, such that the platform 14 having the turbine assembly 12 disposed thereon is coupled to the boom 106. So configured, the boom 106 may be actuated by the power unit 110 while playing out cable 104 from capstan 102 to rotate the boom 106 with the platform 14 and the turbine assembly 12 towards land away from debris in the water 20, for example. In addition, the boom 106 may also be actuated by the power unit 110 while detracting cable 104 with capstan 102 to rotate in a direction away from the land 25a to deploy the platform 14 and the turbine assembly 12 in a desired location in the water, such as the curve before the thalweg in the water 20.

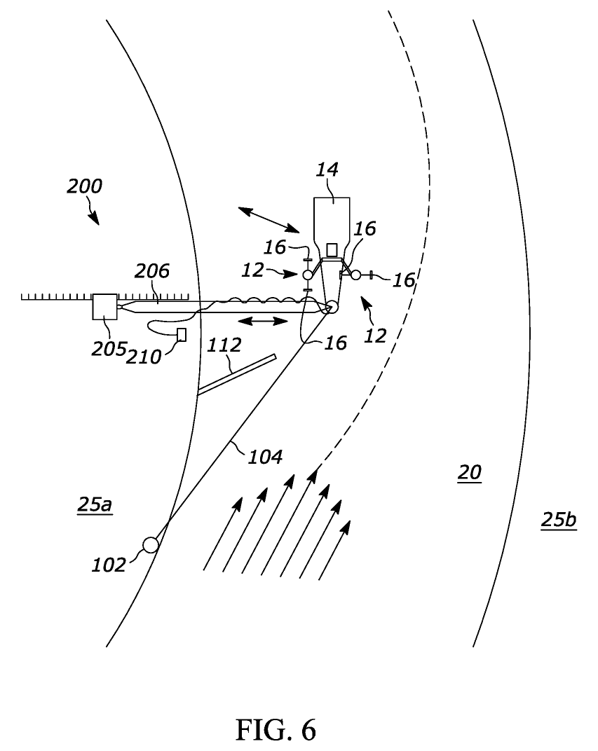

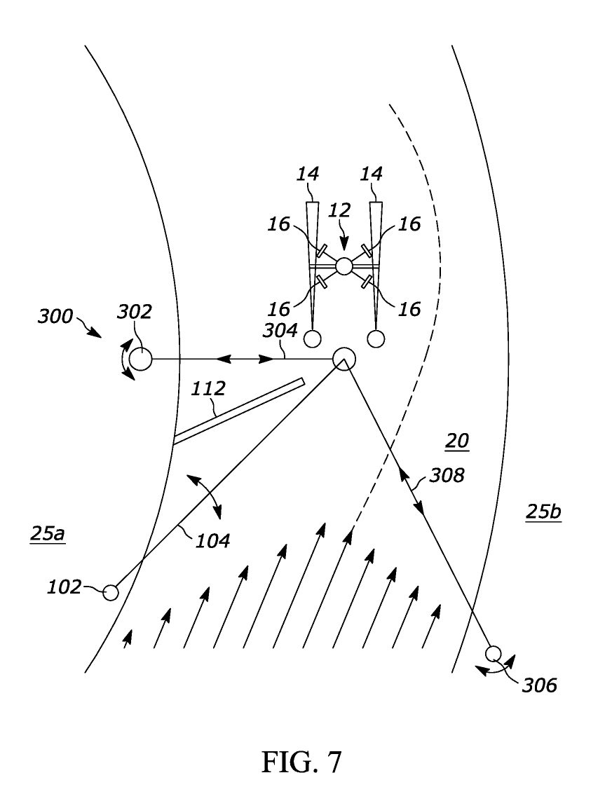

Referring now to FIG. 6, another exemplary system 200 for actuating the turbine assembly 12 and the platform 14 according to yet another aspect of the present disclosure is depicted. The system 200 includes many of the same parts as the system 100 of FIGS. 4 and 5. Thus, parts of the system 200 that are the same as the parts of the system 100 of FIGS. 4 and 5 have the same reference number as the system 100. The system 200 differs from the system 100 in that the system 100 includes a boom that is actuated in a linear direction, as opposed to being rotated in different directions.

For example, the system 200 includes a boom 206 having one end coupled to a portion of either the floating platform 14, as depicted in FIG. 6, or a portion of the turbine assembly 12. An actuator 205 is coupled to the boom 206, such that the actuator 205 moves the boom 206 in a linear direction away from the land upon actuation to deploy the boom 206, and thus the turbine assemblies 12 and the floating platform 14, in a desired location in the water. In another example, the actuator 205 moves the boom 206 in a linear direction toward the land upon actuation to move the boom, and thus the turbine assembly 12 and the floating platform 14, away from debris detected in the water. It will be appreciated that in this embodiment two turbine assemblies 12 are deployed in a symmetric fashion about a single floating platform 14.

Referring now to FIG. 7, another exemplary system 300 for actuating a turbine assembly 12 according to yet another aspect of the present disclosure is depicted. In this example, the system 300 does not include a boom, but instead a pair of capstans and a fixed anchor, as explained more below.

The system 300 includes a capstan 302 configured to be disposed on land 25a and having a cable 304 configured to be coupled to a portion of a turbine assembly disposed in the water 20. The system 300also includes the anchor 102, such as a fixed anchor, configured to be disposed on the land 25a and having the cable 104 configured to be coupled to the same portion of the turbine assembly 12 or floating platform to which the cable 304 of the capstan 302 is attached or another portion of the turbine assembly 12 or floating platform 14. Thus anchored, the floating platform may be located anywhere on a radius defined by cable 104. Additionally, capstan 302 actuates cable 304 which is coupled to floating platform 14 and capstan 306 actuates cable 308 which is coupled to floating platform 14. Thus configured, the position of the floating platform 14 to which the turbine assembly is mounted on may then be moved anywhere on this radius defined by anchor 102 and cable 104 when actuated in a coordinated manner. w

In another example, and as depicted in FIG. 7, the capstan 302 is a first capstan 302, and the system 300 further comprises a second capstan 306 configured to be disposed on the land 25b on a side of the water 20 opposite to the first capstan 302. The second capstan 306 includes a cable 308 configured to be coupled to another portion of the turbine assembly 12 or a portion of the platform 14. So configured, and upon debris being detected, each of the first and second capstans 302, 306 are actuated to deploy the turbine assembly 12 and the platform 14 in a desired location and/or to move the turbine assembly 12 and the platform 14 away from detected debris. When the first capstan 302 is actuated to move the turbine assembly 12 and the platform 14 away from the detected debris, the cable 308 of the second capstan 306 is moved under the water 20, for example, to allow other vessels to pass through this area of the water 20.

Like each of the systems 100, 200 described above, the system 300 also comprises a diverter 112 disposed on the land 25a and extending into the water 20. Upon debris being detected, the cable 304 of the capstan 302 is actuated to move the turbine assembly 12 and the floating platform 14 toward the diverter 112, directing the turbine assembly 12 and the floating platform 14 in an area of the water 20 away from the debris.

As depicted in the FIG. 7, in the system 300, the anchor 102 is disposed on the same side of the land 25a as the first capstan 302, and a length L of the cable 308 extending from the second capstan 306 is greater than a length L of the cable 304 extending from the first capstan 302. As noted, the cable 308 extending from the second capstan 306 is disposed under the water 20 when turbine assembly 12 and the platform 14 are moved away from the debris, allowing another vessel to pass.

In view of the foregoing, it will be appreciated that the foregoing systems 100, 200, and 300 may operate according to one or more of the following methods. For example, and in one example, a method for actuating the turbine assembly 12 comprises deploying the turbine assembly 12 in water 20 by at least one of: (1) a capstan 102, 302, 306 configured to be disposed on land and having a cable coupled to a platform having the turbine assembly or directly to the turbine assembly 12; and (2) a boom 106, 206 configured to be anchored on land 25a and having: a portion coupled to the platform 14 having the turbine assembly 12; or the turbine assembly 12 disposed on the boom 106, 206. The method further includes detecting debris upstream from the turbine assembly 12, and actuating at least one of the cable 104, 304, 308 of the capstan 102, 302, 306 and the boom 106, 206 to move the turbine assembly 12 away from the debris 30.

In some examples, actuating at least one of the cable 104, 304, 308 of the capstan 102, 302, 306 and the boom 106, 206 to move the turbine assembly 12 away from the debris 30 comprises actuating the boom 206 in a linear direction to move the turbine assembly 12 away from the debris and toward land 25a. In another example, actuating at least one of the cable 104, 304, 308 of the capstan 102, 302, 306 and the boom 106, 206 to move the turbine assembly 12 away from the debris 30 comprises actuating the cable 104, 304, 308 of the capstan 102, 302, 306 to move the turbine assembly 12 in area of a diverter 112, diverting the direction of the turbine assembly 12. In yet another example, actuating at least one of the cable 104, 304, 308 of the capstan 102, 302, 306 and the boom 106, 206 to move the turbine assembly 12 away from the debris 30 comprises actuating the cable 304 of the capstan 302, the capstan 302 including a first capstan 302, and actuating a cable 308 of a second capstan 306 coupled to another portion of the turbine assembly 12 to move the turbine assembly 12 disposed on a platform 14 away from the debris 30.

In still another example, actuating at least one of the cable 104, 304, 308 of the capstan 102, 302, 306 and the boom 106, 206 to move the turbine assembly 12 away from the debris 30 comprises actuating the boom 106 by rotating the boom in a direction toward land 25a, thereby moving the turbine assembly 12 disposed on the boom 106 or coupled to the boom 106 away from the debris 30. In another example, the method further comprises deploying the turbine assembly 12 using an anchor 103 configured to be disposed on land 25a and having a cable104 coupled to the turbine assembly 12 and actuating the cable 104 of the anchor 103 to move the turbine assembly 12 away from debris 30 detected.

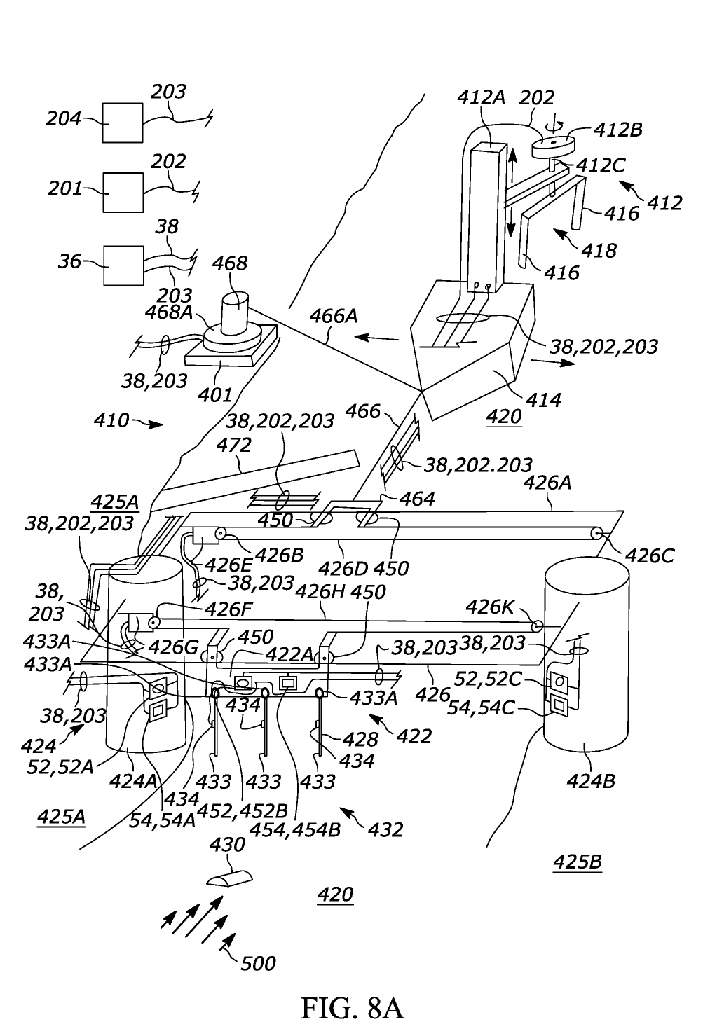

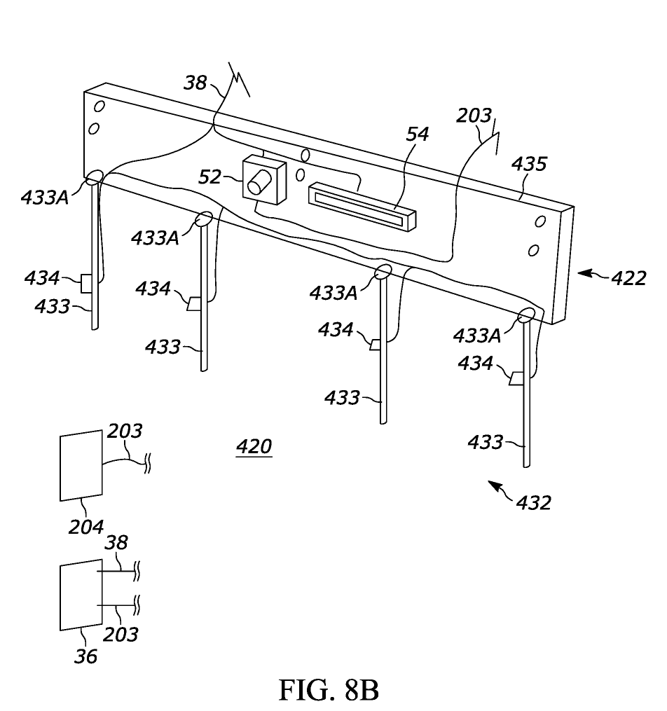

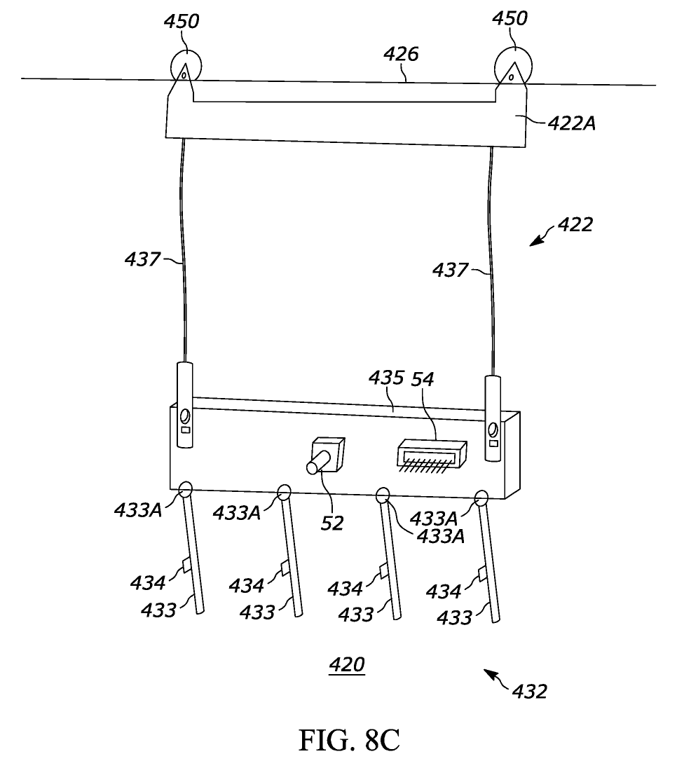

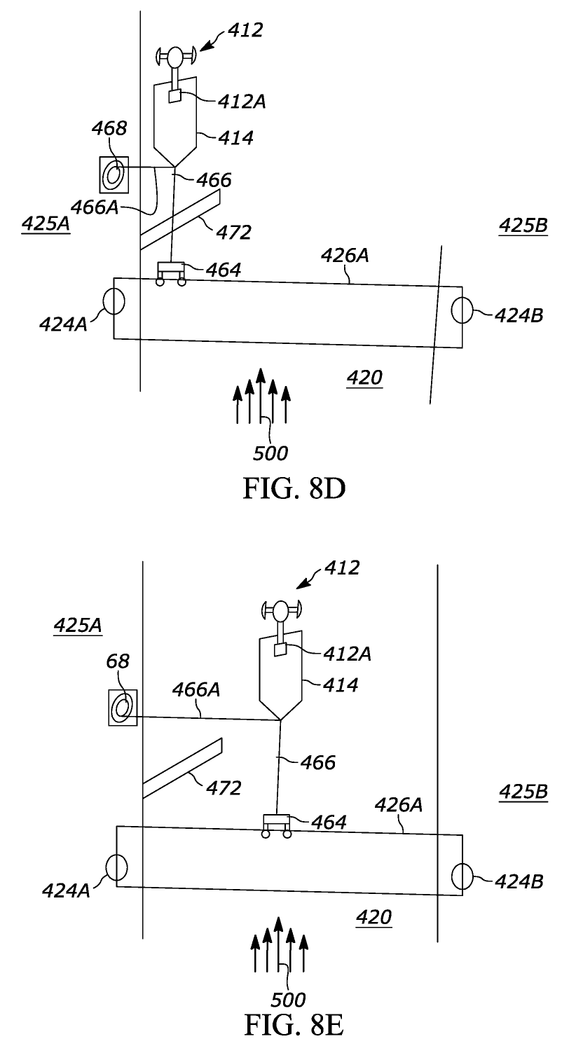

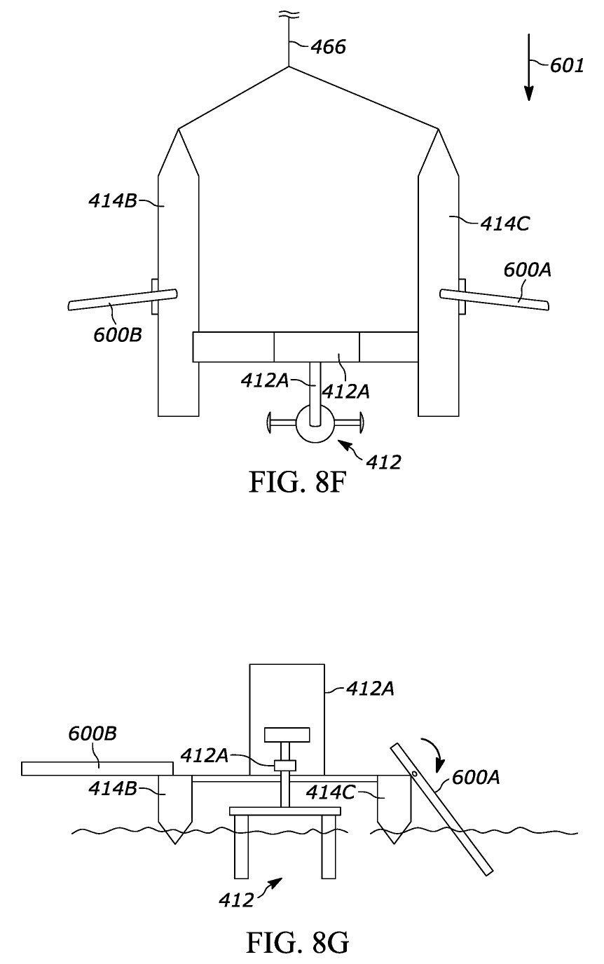

Referring now to FIG. 8A, another system 410 for actuating a turbine assembly 412 is disclosed. In this example, parts of the system 410 that are the same or essentially same as parts of the system 10 of FIGS. 1A-1E include reference numbers 400 more than the system 10 and may not be explained again here in detail for the sake of brevity.

Specifically, the turbine assembly 412 is disposed on a floating platform 414 and includes at least one foil 416 configured to be disposed in water 420. In another example, the at least one foil 416 includes a plurality of foils 418, with each foil 416 also configured to be disposed in water. In another example, only the portion of the at least one foil 416 of the turbine assembly 412 is disposed in the water 420 and removed from the water 420 by a vertical actuator 412A after detecting debris, such as debris 430. In another example, upon detecting debris such as the debris 430, the entire floating platform 414, to which the vertical actuator 412A and turbine assembly 412 including generator 412B and generator shaft 412C which is driven by the plurality of foils 416, are mounted on, is actuated away from the debris 430 or to the shoreline or land 425A, 425B where the shoreline location may be further protected by a permanent diverter structure 472. Actuation of the floating platform 412 is enabled by a cable 466A coupled to the floating platform 414 and motor 468A and capstan 468 and/or carriage 464, which is coupled to the floating platform 414 via cable 466. Cables 466 and 466A are both above water 420. The carriage 464 is actuated by motor 426E (which is coupled to tower 424A), driven pulley 426B, sheaves 450 (which enable the carriage 464 to ride on the cable 426A), transmission belt or cable 426D, and idler pulley 426C in a direction perpendicular or approximately perpendicular to the water 420 current directions.

The system 410 also includes a debris detection system 422 configured to be disposed upstream the turbine assembly 412, as depicted in FIG. 8A, for example. In this example, the debris detection system 422 includes a pair of towers 424 with at least one tower 424a configured to be disposed on land. More specifically, in one example, the pair of towers 424 includes a first tower 424a configured to be disposed on land 425a adjacent to the water 420, and a second tower 424b configured to be disposed on land 425b also adjacent to the water 420 but on an area opposite the land in which the first tower 424a is disposed. Structural cables 426 and 426A are disposed between the pair of towers 424. At least one prong 428 is coupled to debris detection system carriage 422A and suspended from the cable 426 via sheaves 450 and configured to be disposed, at least partially disposed, in the water 420. Debris detection system carriage 422A is actuated by motor 426G which is coupled to tower 424A, driven pulley 426F, transmission belt or cable 426H, sheaves 450, and idler pulley 426K in a direction which is perpendicular or approximately perpendicular to the current direction in the water 420. So configured, this enables adjustment for seasonal river channel migration and ease of maintenance, for example. The at least one prong 428 is configured to detect debris 430 upstream from the turbine assembly 412. The at least one prong 428 may incorporate a flexible joint 433A to enable the prong 428 to rotate when contacted by the debris 430 to minimize damage and avoid buildup of debris 430 on the debris detection system 422. The at least one prong 428 may be constructed of rigid material, such as metal, or a more flexible material, such as elastomer.

In one example, and as depicted in FIG. 8A, the at least one prong 428 includes a plurality of prongs 432 that is coupled to and suspended from the cable 426 and configured to be disposed in the water 420. The plurality of prongs 432 may include any number of prongs 433, such as three prongs 433, as depicted in FIG. 8A. It will be appreciated that more prongs 433 may be included as part of the plurality of prongs 432 and still fall within the scope of the present disclosure. The at least one prong 428 and each prong 433 of the plurality of prongs 432 includes an accelerometer or sensor 434 coupled thereto and configured to detect debris 430 located upstream the turbine assembly 412. Specifically, the accelerometer or sensor 434 will detect impact of any debris contacting the at least one prong 428. It will be appreciated that other devices different from the accelerometer or sensor 434 and capable of detecting debris, such as the debris 430, such as one or more sensors, may additionally or alternatively be coupled to the prongs 428, 433 and still fall within the scope of the present disclosure.

Referring to FIGS. 8A and back to FIG. 1B, the system 410 also includes the at least one computing device 36 communicatively coupled to the at least one prong 428, 433 and the vertical actuator 412A and floating platform actuation motors 468A and 426E by way of wireless network and/or a wired connection, such as multi-conductor electrical data cables 38. The memory 40 of the computing device 36 is executed by the processor 42 and configured to receive a signal from the at least one prong 428 upon the at least one prong 428 detecting debris 430 and sends a signal to the vertical actuator 412A and floating platform actuation motors 468A and 426E to actuate the at least one foil 416 and/or floating platform 414. As a result, the at least one foil 416 of the turbine assembly 412 is removed from the water 420 or the entire floating platform 414 to avoid the debris, such as the debris 430. The computing device 36 may further be programmed with an algorithm which adaptively positions the floating platform 414 relative to the river thalweg 500 so that debris encounters are minimized and power generation is maximized.

In some examples, the system 410 also includes a plurality of cameras 452, and each camera of the plurality of cameras 452 is coupled to one of the towers 424a, 424b of the pair of towers 424 or the cable 426, for example, and further communicatively coupled to the computing device 436. More specifically, and in the example depicted in FIG. 8A, a first camera 452a of the plurality of cameras 452 is coupled to the tower 424a, a second camera 452b is coupled to the debris detection system carriage 422A , and a third camera 452c is coupled to the other tower 424b. It will be appreciated that only a single camera, such as the first camera 452a, may be used or more than three cameras may also be used and still fall within the scope of the present disclosure. So configured, the computing device 436 is configured to receive a signal from at least one camera 452a, 452b, and 452c of the plurality of cameras 452 upon one or more of the cameras 452a, 452b, 452c detecting debris and/or debris contacting the at least one prong 428. Also in this example, a power supply 204 supplies necessary power via power distribution network cable bundle 203 to power the vertical actuator 412A, cameras 452, illumination sources 454, computing device 436, motor 468A, motor 426E, and motor 426G.

In another example, the system 410 may also include a plurality of illumination sources 454, and each illumination source of the plurality of illumination sources 454 is disposed adjacent to each camera 452a, 452b, 452c of the plurality of cameras 452. As such, each illumination source is likewise be coupled to one of the towers 424a, 424b or the debris detection system carriage 422A. More specifically, and again in the example of FIG. 8A, a first illumination source 454a is coupled to the first tower 424a adjacent to the first camera 454a, a second illumination source 454b is coupled to the debris detection system carriage 422A adjacent to the second camera 452b, and the third illumination source 454c is coupled to the tower 424b adjacent to the third camera 452c. It will again be appreciated that fewer or more than three illumination sources may alternatively be used and still fall within the scope of the present disclosure. The illumination sources may emit any electromagnetic radiation type or wavelength, such as infrared radiation, and also still fall within the scope of the present disclosure. It will be appreciated that for any state of the system shown in this example no cables are in contact with the water, and that the only system component which cannot be removed from the water is the floating platform 414, which can be positioned near shore and behind diverter 472, for example.

Referring now to FIG. 8B, a portion of the debris detection system 422 is depicted. Specifically, in this example, the plurality of prongs 432 extends from a body 435, with each prong 433 coupled to the body 435 via a flexible joint 433A such that only a portion of each prong 433 is disposed in the water. Each prong 433 includes an integrated sensor 434. In addition, the at least one camera 452 is coupled to the body 435 along with the at least one illumination source 454, which is disposed adjacent to the at least one camera 452. The at least one camera 452 is communicatively coupled via multi-conductor electrical data cable 38 to the computing device 36 of FIG. 1B. So configured, the body 435 enables this portion of the debris detection system 422 to be more easily disposed on various other structures, e.g., a boom, as explained more below, and still function as described above, for example. The at least one camera 452 and the at least one illumination source 454 are connected to a power source 204 via power distribution network cable bundle 203.

Referring now to FIG. 8C, the at least one prong 433 with integrated sensor 434 of the plurality of prongs 432 is coupled to the body 435 via flexible joint 433A. Furthermore in this example the body 435 is coupled to arms 437, which are coupled to the debris detection system carriage 422A coupled to cable 26 via sheaves 450. Thus, the debris detection system 422 in this example may travel easily in a direction parallel to cable 426 to enable adjustment of its position or access for maintenance. Each prong 433 of the plurality of prongs 432 is disposed in the water, for example.

Referring now to FIGS. 8D and 8E, FIG. 8D shows a simplified depiction of the system shown in FIG. 8A, where the vertical actuator 414A has raised the turbine assembly 412 fully out of the water 420 and the floating platform 414 is retrieved to a safe position near shore behind diverter 472. FIG. 8E shows a simplified depiction of the system shown in FIG. 8A, where the floating platform 414 is deployed to an optimal position for power generation.

As depicted in FIGS. 8F and 8G, it should be noted that the floating platform 414 may be catamaran or other configuration so that the hull of the platform 414 removes a minimal amount of kinetic energy from the current of the water 420, which acts on the turbine assembly 412. Also as shown in FIGS. 8F and 8G, the floating platform 414 may incorporate retractable drag devices 600A and 600B, so that when only one drag device 600A, 600B is lowered into the water the floating platform 414 will present an angle of attack relative to the river flow direction 601 (FIG. 8F) and be propelled in a direction perpendicular to the current of the water 420, such as in the case of a reaction ferry. These drag devices 600A, 600B may optionally be used to assist with moving the floating platform 414 between shore and a deployed position. These drag devices 600A and 600B may optionally be automatically actuated.

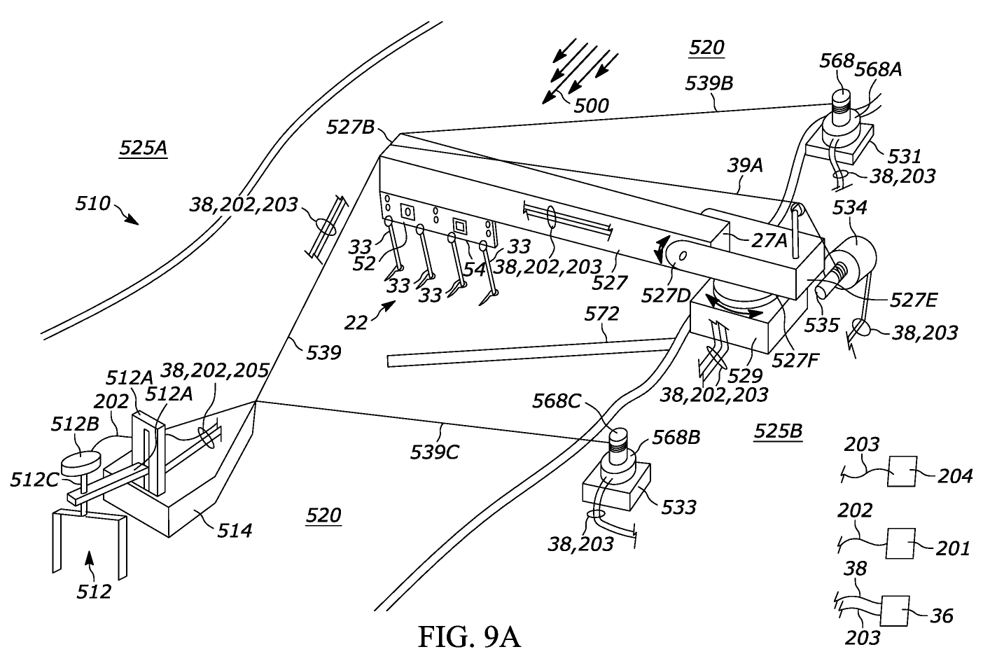

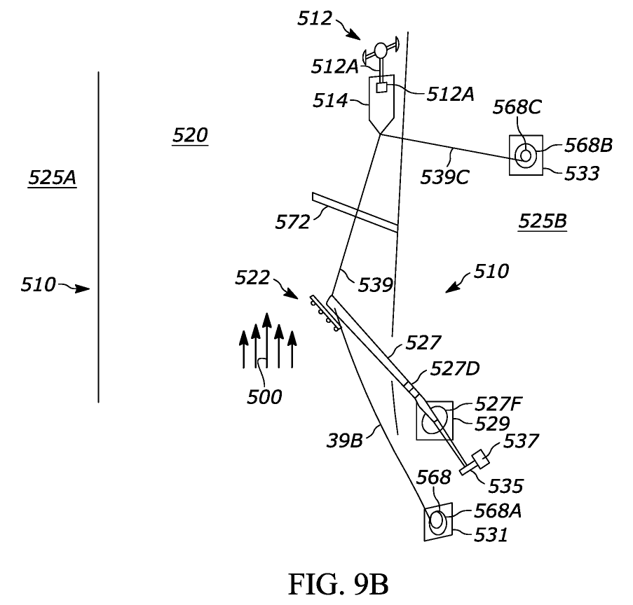

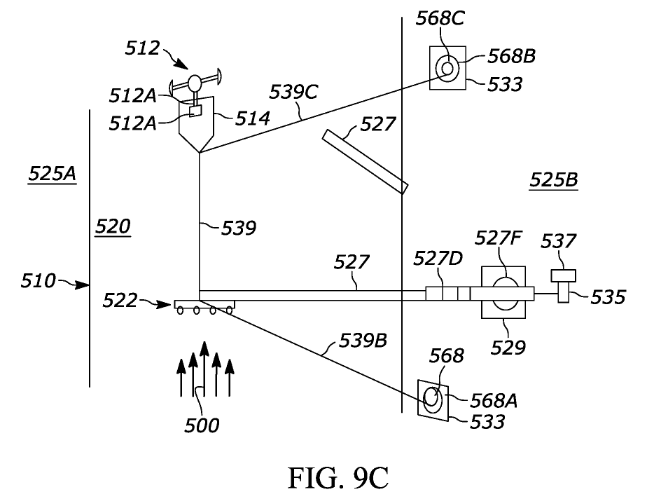

Referring now to FIG. 9A, another system 510 for actuating a turbine assembly 512 according to another aspect of the present disclosure is depicted. Parts of the system 510 that are similar to or the same as parts of the system 10 of FIGS. 1A -1E have a reference number 400 more than the reference numbers of the system 10 of FIGS. 1A-1E and may not be described again in detail here for the sake of brevity. Unlike the systems 10 and 410, for example, described above, the debris detection system of the system 510 is coupled to a boom 527, as explained more below.

Specifically, the debris detection system 522 depicted in FIG. 9A is coupled to a boom 527. In this example, the boom 527 is in a deployed position so that the prongs 533 of the debris detection system are disposed in water 520. The boom 527 includes a first end 527a coupled to a pivot 527D and disposed on land 525b. The pivot 527D is coupled to a base 527E and turntable 527F, and a winch 535 powered by motor 534 may actuate cable 539A so that the second end of the boom 527B, which is disposed above the water 520, may be raised or lowered in the vertical plane. The base 527e is coupled to turntable 527F, which is mounted on pedestal 529; by this arrangement the boom 527 is enabled to rotate in a horizontal plane. The debris detection system 522 is coupled to this second end of the boom 527B. The floating platform 514, which the vertical actuator 512A and turbine assembly 512 are mounted on, is coupled to the second end 527b of the boom 527 via a cable 539. The second end 527B of the boom 527 is further coupled via cable 539B to a capstan 568, which is powered by motor 568A and mounted on tower 531, which is disposed on the land 525b. Therefore, the position of the floating platform 514 may be adjusted, by actuating motor 568A to effectively increase the length of cable 539B. This allows the current to move/actuate the floating platform 514 closer to shore, or by actuating motor 568A to effectively decrease the length of cable 539B to move the floating platform 514 away from shore and upstream. Additionally, a second capstan 568C powered by motor 568B and mounted on tower 529 may actuate cable 539C that is coupled to the floating platform 514. This enables more rapid retrieval or closer proximity to shore when retrieved, such as behind diverter structure 572. Alternatively, cables 539B and 539 may be of a fixed length and rigidly attached to the end of the boom 527B, so that the boom may be rotated is a desired manner by coordinated actuation of capstans 568 and 568C.

The computer device 36, which is explained in detail above and in FIG. 1B, for example, may be communicatively coupled to the turbine assembly 512 and further communicatively coupled to the power distribution system 204, power distribution network cable bundle 203, and/or power generation cable 202 connecting to grid or battery charging system 201, as also explained more above.

It will be appreciated that no cables are in contact with the water 520 for any system 510 operating state, and that the only system component which cannot be removed from the water is the floating platform 514. However, the floating platform 514 may be positioned near shore and behind diverter 572.

Referring now to FIG. 9B, the turbine assembly 512 of the system 510 is depicted in a retracted position. Specifically, the vertical actuator 512A has raised the turbine assembly 512 out of the water 520. In addition, the boom 527 is rotated in horizontal plane downstream and rotated upward in vertical plane by 537 and 535 so the end 527B is moved upward and debris detection system 522 is out of the water 520. Further, the floating platform 514 is positioned behind the diverter 572.

FIG. 9C depicts the turbine assembly 522 of the system 510 of FIG. 9A in a deployed position. Specifically, the vertical actuator 512A has lowered the turbine assembly 512 into the water 520. In addition, the boom 527 is rotated in a horizontal plane upstream and downward in a vertical plane by 537 and 535 so end 527B is moved downward and debris detection system 522 is partially disposed in water 520 at a nominal operating position. In addition, the floating platform 514 is positioned to optimally generate power. So configured, none of the wires or cables, e.g., the power cable 202, or anchoring cables (from capstan or carriage to floating platform, or multi-conductor electrical data cable 38) is disposed underwater.

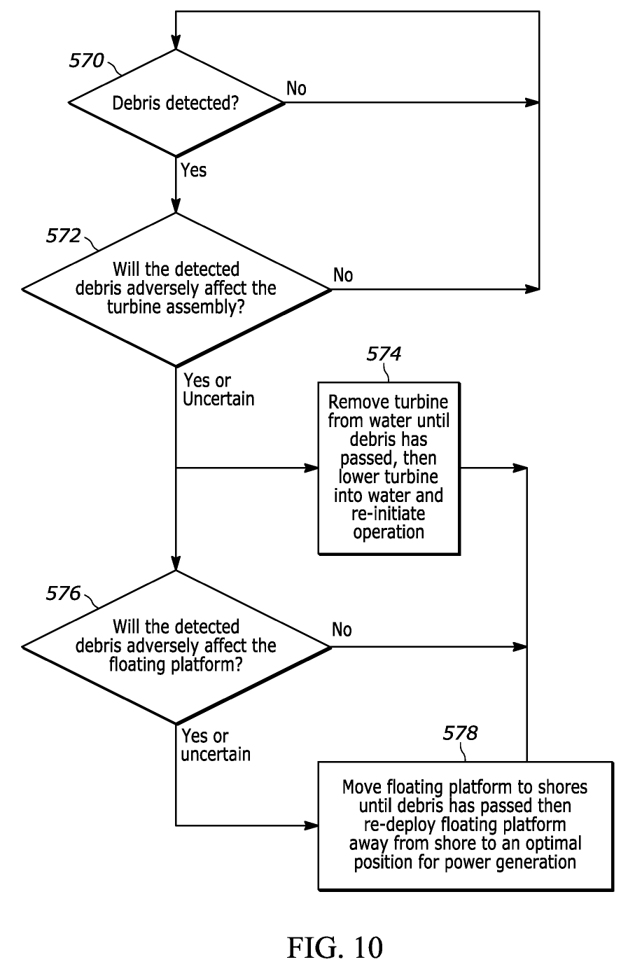

Referring now to FIG. 10, one of ordinary skill in the art will understand that the system 10, 110, 210, 310, 410, 510 described above may operate according to another method for actuating a turbine assembly depicted therein in flow chart form. Specifically, the method includes continuous monitoring and detecting of any debris by the debris detection system 22, 122, 222, 322, 422, 522 at block 570. If no debris is detected, the system continues to monitor and detect debris at block 570. However, if debris is detected, the method further includes determining if the detected debris will adversely affect the turbine assembly debris detected at block 572. If the debris detected is small and/or is not of concern, no action is taken, and the debris detection system 22, 122, 222, 322, 422, 522 continues monitoring for any other debris at block 570. However, if the debris detected may potentially damage the turbine assembly 12, 112,212, 312, 412, 512 and/or if it is determined to be uncertain, the method further includes actuating the turbine assembly 12, 112, 212, 313, 412, 512 (and/or removing the turbine assembly 12, 112, 212, 312, 412, 512) vertically out of the water until debris is passed at block 574. Once debris is passed, the method further includes re-initiating the turbine operation, e.g., lowering the turbine assembly 12, 112, 212, 312,412, 512 back into the water again at block 574, and then monitoring and detecting for any debris in block 570.

At block 576, the method further includes determining if the debris detected adversely affects the floating platform 14, 114, 214, 314, 414, 514. If it is determined the debris will not adversely affect the floating platform 14, 114, 214, 314, 414, 514, the method then continues to monitoring and detecting debris in block 570. However, if it is determined the debris will adversely affect and/or may damage the floating platform 14, 114, 214, 314, 414, 514, the method then further includes moving the entire floating platform 14, 114, 214, 314, 414, 514 away from debris or to shore and behind the permanent diverter until debris has passed at block 578. Once the debris has passed, the method may then include re-deploying the floating platform 14, 114, 214, 314, 414, 514 back into the water also at block 578.

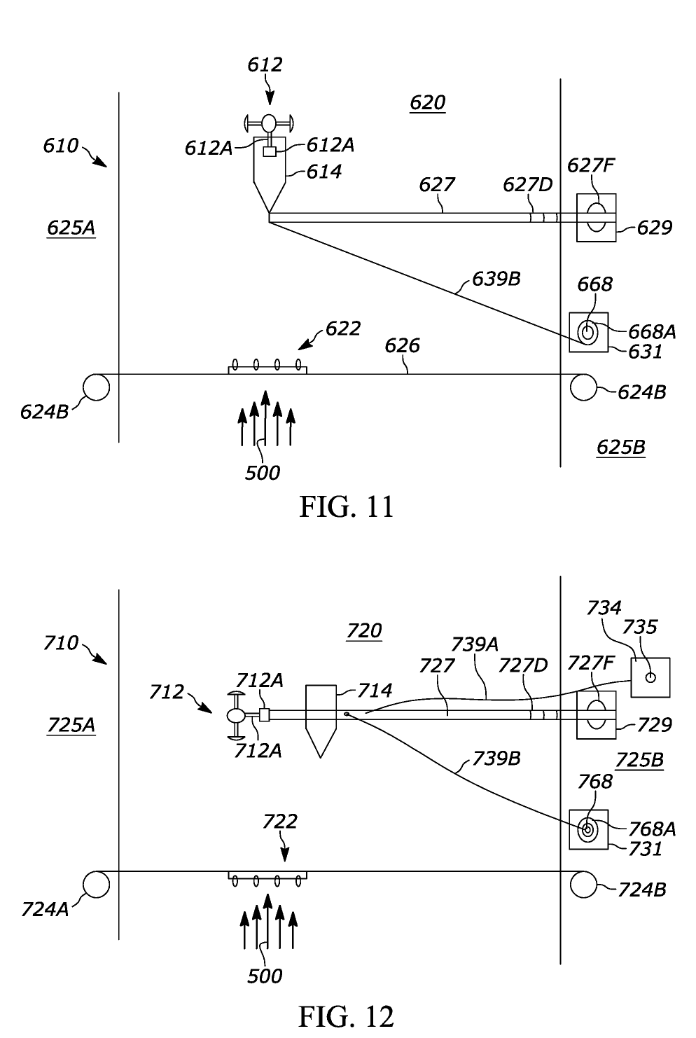

Referring now to FIGS. 11-13, FIG. 11 depicts a variant of the system 510 shown in FIG. 9A, for example. In FIG. 11, another system 610 for actuating a turbine assembly 612 according to another aspect of the present disclosure is depicted. Parts of the system 610 that are similar to or the same as parts of the system 10 of FIGS. 1A -1E have a reference number 500 more than the reference numbers of the system 10 of FIGS. 1A-1E and are not described again in detail here for the sake of brevity. In the system 610, the boom 627 is directly coupled to the floating platform 614, and the debris detection system 622 is deployed by other means, such as by an overhead cable 626 as described above in the system shown in FIG. 1A.

FIG. 12 depicts another system 710 for actuating a turbine assembly 712 according to yet another aspect of the present disclosure. Parts of the system 710 that are similar to or the same as parts of the system 10 of FIGS. 1A -1E have a reference number 600 more than the reference numbers of the system 10 of FIGS. 1A-1E and are described again in detail here for the sake of brevity. In the system 710, a variant of the system shown in FIG. 2A, the boom 727 is directly coupled to both the floating platform 714 and vertical actuator 712a (which is coupled to the turbine assembly 712). In addition, the debris detection system 722 is deployed by other means, such as by an overhead cable 726, as described above in the system 10 shown in FIG. 1A. In this embodiment, motor 734 may actuate capstan 735 so that cable 739A is retracted and the end of the boom 727A is raised in the vertical plane so that the floating platform 714 and turbine assembly 712 are raised completely out of the water 720.

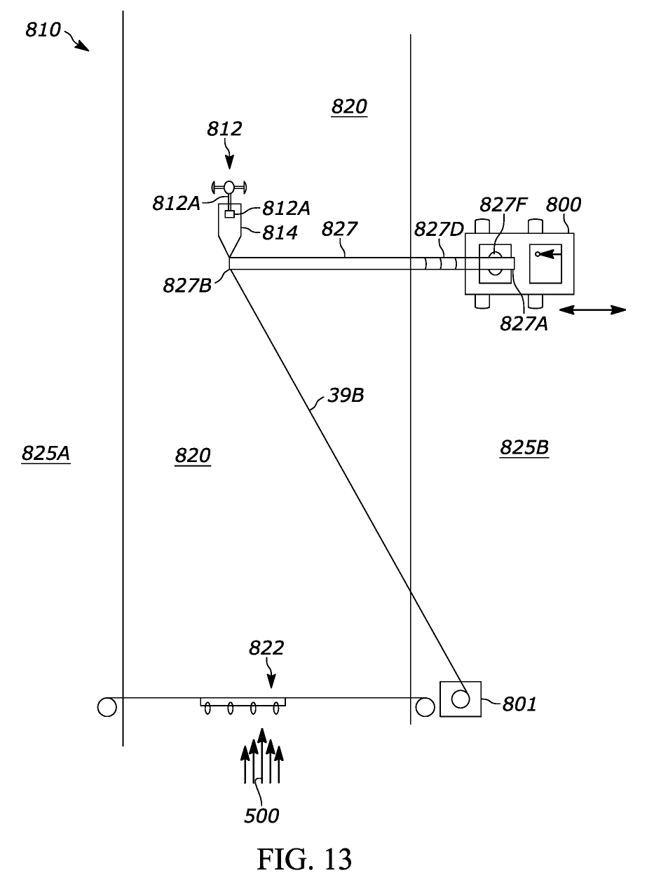

Referring now to FIG. 13, another system 810 for actuating a turbine assembly 812 according to yet another aspect of the present disclosure is depicted. Parts of the system 810 that are similar to or the same as parts of the system 10 of FIGS. 1A -1E have a reference number 700 more than the reference numbers of the system 10 of FIGS. 1A-1E and are described again in detail here for the sake of brevity. In the system 810, the boom 827 is coupled directly to the floating platform 814 at end 827B, and is mounted on a linear actuator or vehicle 800, such as a truck. The debris detection system 822 is deployed by other means, such as an overhead cable as described above in the system shown in FIG. 1A. The system 810 also includes a fixed anchor point 801 disposed upstream of the turbine assembly 812 and enables a simpler/lower cost method of deployment, for example. For all of the system variants shown in FIGS. 11-13, a person having ordinary skill in the art will understand that no anchor cables, power cables, or electrical data cables are or will be disposed in water 620, 720, 820.

In view of the foregoing, it will be appreciated that the new systems and methods described above include several advantages. For example, the new systems and methods enable all anchor lines, power cables (from generator to shore, to power homes, etc.), and data cables to be routed above water so they are not damaged by the silty water, which acts like sandpaper to scour and damage anything in it. In addition, the debris detection system may be mounted in a variety of ways upstream of the turbine assembly, which informs the turbine vertical actuator to move it vertically up out of the water and also possibly the deployment system to move the whole turbine and floating platform to the side of the river. Moreover, the deployment system enables the turbine assembly to be deployed from the land/shore without special equipment and without using boats or other related equipment. Still further, the deployment system enables all cables and electrical wires to be routed above water, preventing any wear and/or damage to any cable from various elements in the water, for example.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

As used herein any reference to “one example” or “an example” means that a particular element, feature, structure, or characteristic described in connection with the embodiment is included in at least one embodiment. The appearances of the phrase “in one example” in various places in the specification are not necessarily all referring to the same example.

Some examples may be described using the expression “coupled” and “connected” along with their derivatives. For example, some examples may be described using the term “coupled” to indicate that two or more elements are in direct physical or electrical contact. The term “coupled,” however, may also mean that two or more elements are not in direct contact with each other, but yet still cooperate or interact with each other. The examples are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B is true (or present).

In addition, use of the “a” or “an” are employed to describe elements and components of the embodiments herein. This is done merely for convenience and to give a general sense of the description. This description, and the claims that follow, should be read to include one or at least one and the singular also includes the plural unless it is obvious that it is meant otherwise.

While various embodiments have been described herein, it is understood that the appended claims are not intended to be limited thereto, and may include variations that are still within the literal or equivalent scope of the claims. Although the assembly, system, methods, and elements thereof, have been described in terms of exemplary embodiments, they are not limited thereto. The detailed description is to be construed as exemplary only and does not describe every possible embodiment of the invention because describing every possible embodiment would be impractical, if not impossible. Numerous alternative embodiments could be implemented, using either current technology or technology developed after the filing date of this patent that would still fall within the scope of the claims defining the invention.

It should be understood that the legal scope of the invention is defined by the words of the claims set forth at the end of this patent. The appended claims should be construed broadly to include other variants and embodiments of the same, which may be made by those skilled in the art without departing from the scope and range of equivalents of the assembly, system, and methods.

What is claimed:

1. A system for actuating a turbine assembly comprising:
a debris detection system configured to be disposed upstream of one or more of a floating platform or a turbine assembly having at least one foil configured to be disposed in water, the debris detection system comprising:
at least one prong configured to be disposed in water, the at least one prong configured to detect debris upstream from the turbine assembly; and
a computing device communicatively coupled to the at least one prong and the turbine assembly, the computing device having a memory executed by a processor and configured to:
receive a signal from the at least one prong upon the at least one prong detecting debris; and
send a signal to one or more of the floating platform or the turbine assembly to actuate one or more of: (1) the at least one foil of the turbine assembly to remove the at least one foil of the turbine assembly from the water; and (2) the floating platform in a direction away from the debris or to a shoreline.

2. The system of claim 1, wherein the at least one prong includes a plurality of prongs configured to be disposed in the water and coupled to one of a cable, a boom, or a carriage suspended from a cable by at least one sheave, each prong of the plurality of prongs including a sensor coupled thereto and configured to detect debris upstream the turbine assembly.

3. The system of claim 1, further comprising a plurality of cameras, each camera of the plurality of cameras coupled to one of: a tower of a pair of towers to which the cable is disposed; or the boom, and each camera communicatively coupled to the computing device, such that the computing device is configured to receive a signal from at least one camera upon the camera detecting debris and/or debris contacting the at least one prong.

4. The system of claim 3, further comprising a plurality of illumination sources, each illumination source disposed adjacent to each camera of the plurality of cameras.

5. The system of claim 1, wherein the computing device is communicatively coupled to a vertical actuator coupled to the floating platform and the turbine assembly, the floating platform having at least one floating platform actuator, such that the computing device sends the signal to the vertical actuator and the floating platform actuator to actuate the entire floating platform in a direction away from the debris or to a shoreline.

6. The system of claim 3, wherein the pair of towers is first pair of towers, and the system further comprises a second pair of towers, a cable disposed between the second pair of towers, and a carriage disposed on the cable disposed between the second pair of towers and having another cable extending therefrom and coupled to a portion of the turbine assembly, and wherein upon the debris detection system detecting debris, the carriage actuates the cable to move the turbine assembly away from the detected debris.

7. The system of claim 1, further comprising a capstan configured to be disposed on or above land and having a cable extending therefrom and coupled to a portion of the turbine assembly, wherein upon the debris detection system detecting debris, the cable of the capstan is actuated to move the turbine assembly away from the detected debris, and, optionally, a diverter disposed on land and extending into the river, wherein the cable of the capstan is actuated to move the turbine assembly toward the diverter, which then directs the turbine assembly in an area of the water away from the debris.

8. The system of claim 1, further comprising one or more of a cable to which a carriage coupled to the debris detection system is suspended and a wire configured to be coupled to a portion of the turbine assembly, and neither the cable nor the wire is in contact with the water in any state of the system.

9. A method for actuating a turbine assembly, the method comprising:
disposing a debris detection system upstream a turbine assembly having at least one foil configured to be disposed in water, the debris detection system comprising at least one prong configured to be disposed in water and coupled to one of a cable or a boom;
detecting debris upstream from the turbine assembly by the at least one prong;
receiving a signal from at least one component of the debris detection system indicating the debris is detected; and
actuating one or more of: the turbine assembly to remove the at least one foil of the turbine assembly from the water; and an entire floating platform to which the turbine assembly is coupled away from the debris or to a shoreline.

10. The method of claim 9, wherein disposing a debris detection system upstream a turbine assembly having at least one foil configured to be disposed in water, the debris detection system comprising at least one prong configured to be disposed in water comprises disposing the debris detection system upstream the turbine assembly, the at least one prong including a plurality of prongs, each prong of the plurality of prongs configured to be disposed in the water and having an accelerometer or sensor coupled thereto.

11. The method of claim 9, wherein detecting debris upstream from the turbine assembly by the at least one prong comprises detecting debris upstream from the turbine assembly by a plurality of prongs, each prong having a portion disposed in the water and an accelerometer or sensor coupled thereto.

12. The method of claim 9, wherein receiving a signal from at least one component of the debris detection system indicating the debris is detected comprises receiving a signal from at least one of: (1) the at least one prong of the debris detection system; and (2) at least one camera coupled to at least one tower indicating debris is contacting the at least one prong.

13. The method of claim 12, wherein receiving a signal from at least one component of the debris detection system indicating the debris is detected comprises receiving a signal from a plurality of cameras, each camera coupled to a tower and indicating debris is present on the water surface.

14. The method of claim 9, wherein actuating the at least one foil of the turbine assembly to remove the at least one foil of the turbine assembly from the water comprises vertically actuating the at least one foil of the turbine assembly to remove the at least one foil of the turbine assembly from the water.

15. The method of claim 9, wherein actuating the turbine assembly to remove the at least one foil of the turbine assembly from the water comprises one or more of: (1) actuating the at least one foil of the turbine assembly to remove the at least one foil of the turbine assembly from the water; and (2) sending a signal via a processor of a computing device communicatively coupled to the at least one prong and the turbine assembly to actuate the at least one foil of the turbine assembly to remove the at least one foil of the turbine assembly from the water.

16. The method of claim 9, further comprising disposing the turbine assembly on a floating platform, such that only a portion of the at least one foil is disposed in the water.

17. A system for actuating a turbine assembly comprising:
a capstan configured to be disposed on land and having a cable configured to be coupled to a portion of a turbine assembly disposed in water; and
a boom configured to be anchored on land and having a portion coupled to a floating platform on which the turbine assembly is disposed;
wherein upon debris being detected, one or more of the cable of the capstan or the boom is actuated to move the floating platform having the turbine assembly away from the debris or to the shoreline.

18. The system of claim 17, further comprising a diverter disposed on land and extending into the water, wherein upon debris being detected, the cable of the capstan is actuated to move the turbine assembly toward the diverter, directing the turbine assembly in an area of the water away from the debris, and wherein the diverter protects the shoreline when the floating platform having the turbine assembly is moved away from the debris.

19. The system of claim 17 , further comprising at least one tower configured to be disposed on land, and wherein one of: (1) the capstan is disposed on the tower, such that the cable coupled to the portion of the turbine assembly is disposed entirely above the water; or (2) the capstan is configured to be disposed on land and the cable is coupled to the tower and to the boom.

20. The system of claim 17, further comprising a power unit communicatively coupled to the boom, wherein the boom is actuated by the power unit to rotate in a direction toward land, moving the turbine assembly away from the debris.

21. The system of claim 17, wherein the turbine assembly is disposed on a platform, and at least one or more of: (1) the boom is coupled to the platform; and (2) the capstan is coupled to the platform, such that one or more of the boom or the capstan is configured to deploy the platform having the turbine assembly disposed thereto into water and actuate the platform to move the platform and turbine assembly away from debris when detected.

22. The system of claim 17, wherein the boom has a portion coupled to the turbine assembly, and further comprising an actuator coupled to the boom, such that the actuator moves the boom in a linear direction upon actuation to either deploy the turbine assembly in water or move the turbine assembly in the water away from detected debris.

23. A method for actuating a turbine assembly, the method comprising:
deploying a turbine assembly in water by at least one of: (1) a capstan configured to be disposed on land and having a cable coupled to a platform having the turbine assembly; and (2) a boom configured to be anchored on land and having: a portion coupled to the platform having the turbine assembly; or the turbine assembly disposed on the boom;
detecting debris upstream from the turbine assembly; and
actuating at least one of the cable of the capstan and the boom to move the turbine assembly away from the debris.

24. The method of claim 23, wherein actuating one of the cable of the capstan or the boom to move the turbine assembly away from the debris comprises actuating the boom in a linear direction to move the turbine assembly away from the debris and toward land.

25. The method of claim 23, wherein actuating one of the cable of the capstan or the boom to move the turbine assembly away from the debris comprises actuating the cable of the capstan to move the turbine assembly in area of a diverter, diverting the direction of the turbine assembly.

26. The method of claim 23, wherein actuating one of the cable of the capstan or the boom to move the turbine assembly away from the debris comprises actuating the cable of the capstan, the capstan including a first capstan, and actuating a cable of a second capstan coupled to another portion of the turbine assembly to move the turbine assembly disposed on a platform away from the debris.

27. The method of claim 23, wherein actuating one of the cable of the capstan or the boom to move the turbine assembly away from the debris comprises actuating the boom by rotating the boom in a direction toward land, thereby moving the turbine assembly disposed on the boom or coupled to the boom away from the debris.

28. The method of claim 23, further comprising deploying the turbine assembly using an anchor configured to be disposed on land and having a cable coupled to the turbine assembly and actuating the cable of the anchor to move the turbine assembly away from debris detected.

29. A method for actuating a turbine assembly, the method comprising:
detecting, via a debris detection system, debris;
upon debris being detected, determining if the debris detected adversely affects a turbine assembly;
upon determining the debris adversely affects the turbine assembly, actuating the turbine assembly to remove the turbine assembly out of water until the debris passes;
after determining the debris detected adversely affects the turbine assembly, determining if the debris detected adversely affects a floating platform; and
upon determining the debris detected adversely affects the floating platform, actuating the floating platform to move the floating platform away from the detected debris and/or to a shoreline until the debris passes.
